(19) United States
(12) Patent Application Publication
(10) Pub. No.: US 2011/0161134 A1
(43) Pub. Date: Jun. 30, 2011

(54) Expansion of Market Coverage

(75) Inventors: Nat G. Adkins, JR., Richmond, TX (US); Cynthia Barratt, Richmond, TX (US)

(73) Assignee: OCUSOFT, INC., Rosenberg, TX (US)

(21) Appl. No.: 12/648,897

(22) Filed: Dec. 29, 2009

(51) Int. Cl. G06Q 10/00; G06Q 50/00

(52) U.S. Cl. 705/7.29

(57) ABSTRACT

Methods and systems for funding an expansion of market coverage. One or more sales territories are initially identified for coverage, a pre-defined ranking is assigned to each of the sales territories, a capital contribution level is established for receiving a corresponding pre-determined capital contribution, wherein the capital contribution level is directly related to the sales territory ranking, and directing the capital contribution toward financing one or more sales representatives placed in each of the sales territories.

### BACKGROUND AND SUMMARY

This invention relates generally to expanding market coverage for products and services. More particularly, the invention relates to one or more methods and systems for financing an outside sales force to achieve expanded market penetration. Companies, and in particular, small businesses, face many obstacles when trying to penetrate or expand market share. Access to finances and adequate manpower are perennial challenges.

The one or more embodiments of the invention may allow a company to expand its sales representative coverage for its products and/or services and to increase the value of the company's shares without a significant outlay of funds. In one embodiment of the invention, a computer-implemented method for funding an expanded market coverage may include identifying one or more sales territories for coverage, assigning a pre-defined ranking to each of the sales territories, establishing a capital contribution level for receiving a corresponding pre-determined capital contribution, wherein the capital contribution level is directly related to the sales territory ranking, and directing the capital contribution toward financing one or more sales representatives placed in each of the sales territories.

The capital contribution may be received as cash or property from one or more contributors. The contributors may be individuals or companies, including the company that seeks to expand its market coverage. The sales representatives are financed until one or more pre-determined sales objectives are achieved in the sales territories. The pre-determined sales objectives may comprise desired market penetration and customer traction, product or service recall by target customer base, and realized sales revenues.

The identification of the sales territories may include determining one or more preliminary factors for the identification of the sales territories, and retrieving and analyzing data satisfying the sales-territory identification factors. The preliminary factors may comprise one or more geographic locations, demographic indicators, quantitative values or qualitative values. The data satisfying the sales-territory identification factors may comprise information on current and/or historic sales of one or more products and/or services. In one embodiment of the invention, the products may be selected from the group consisting of prescription and over the counter pharmaceutical products and medical devices. The data satisfying the sales-territory identification factors may comprise information on prescriptions written in the sales territory. The information on the prescriptions may further comprise data on the prescribed medications, and the number of prescriptions written for one or more medical products in the identified sales territories. This information may be stored in one or more databases accessible by computer means.

A fixed percentage of net profits generated from sales in the sales territory may be disbursed to the one or more contributors. The disbursement may comprise a pre-determined interest accrued on the capital contributions. The interest may be disbursed pro-rata in accordance with the capital contribution level of the contributors. Surplus revenues, after payment of the interest, may be distributed to the one or contributors until the capital contributions are completely repaid.

In another embodiment of the invention, a method for funding an expanded market coverage may comprise setting up a new business entity, wherein the business entity comprises a designated general partner and one or more limited partners; determining one or more preliminary factors for the identification of one or more sales territories; retrieving and analyzing data satisfying the sales-territory identification factors; assigning a pre-defined ranking to each of the identified sales territories; establishing a capital contribution level for receipt of a corresponding pre-determined capital contribution from the one or more limited partners, the capital contribution level associated with the sales territory ranking; and directing the capital contributions received toward financing one or more sales representatives placed in the sales territories. The sales territory ranking may be based on future sales potential.

Each of the limited partners continually contributes their capital, for a pre-determined duration, to finance commercial activities of the one or more sales representatives placed in each of the sales territories.

In one embodiment of the invention, the business entity is a limited partnership. Each of the limited partners may acquire a percentage interest in the limited partnership commensurate to its capital contribution. After pre-determined objectives are met in each sales territory, a fixed commission for the sales in the sales territory may be paid to the limited partnership. From the commission, each of the limited partners may be paid a pre-determined amount as interest accrued on their capital contribution. The amount may directly correspond to the capital contribution level. The capital contributions of each of the one or more limited partners may be repaid from surplus revenues after payment of the accrued interest. Upon payment of accrued interest and the repayment of the capital contribution, each of the percentage interests in the limited partnership may be retired. The limited partnership may further comprise a general partner responsible for recruiting, training and managing the sales representatives. The general partner may be compensated for expenses related to the sales representative recruiting, training and managing prior to paying the accrued interest to the limited partners.

In yet another embodiment, a computer-implemented system for funding an expanded market coverage includes a processor, and a computer memory operatively coupled to the processor, wherein the computer memory has disposed within it computer program instructions for: identifying one or more sales territories for coverage; assigning a pre-defined ranking to each of the sales territories; establishing a capital contribution level for receipt of a corresponding pre-determined capital contribution, wherein the capital contribution level is associated with the sales territory ranking; and directing the capital contribution toward financing one or more sales representatives placed in the sales territories.

The system further comprises computer program instructions for: determining one or more preliminary factors for the identification of the sales territories; and retrieving and analyzing data satisfying the sales-territory identification factors. The data satisfying the sales-territory identification factors may comprise information on current and/or historic sales of one or more products and/or services. The products may be selected from the group consisting of prescription and over the counter pharmaceutical products and medical devices. These and other embodiments of the invention are described in detail with reference to the following drawings.

### BRIEF DESCRIPTION OF THE DRAWINGS

FIG. 1 illustrates a flowchart in accordance with a computer-implemented method in accordance with one embodiment of the invention.

FIG. 2 illustrates a flowchart in accordance with another embodiment of the invention.

### DETAILED DESCRIPTION

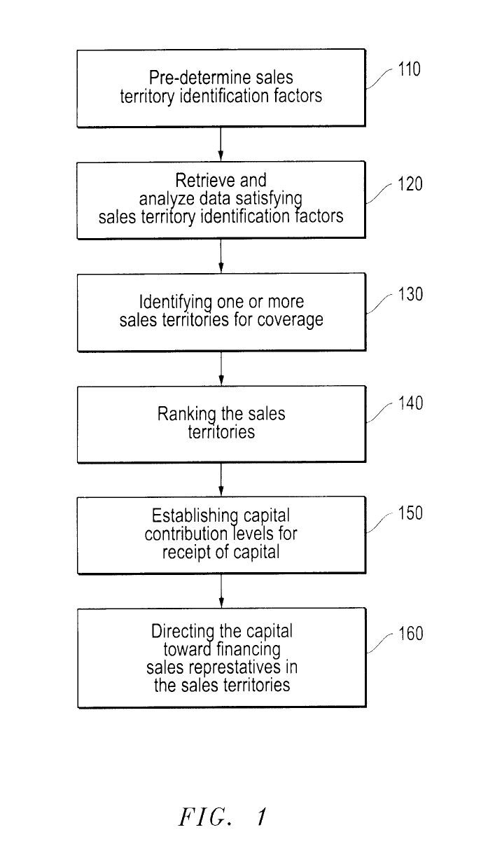

The one or more embodiments of the invention include methods and systems for financing sales representatives in one or more regions or territories across the country. Referring to FIG. 1, an entity seeking to expand market coverage may utilize computer means to pre-determine one or more preliminary factors relevant for the identification of sales territories 110. The preliminary factors may be industry, entity or product or service line specific. The preliminary factors may comprise designated or targeted geographic locations, demographic indicators, quantitative values or qualitative values. In one embodiment of the invention, the preliminary factors comprise information on prescriptions written in a territory. Data satisfying the preliminary factors may be stored in one or more databases or computer readable media and may be accessible using a computer. This data may be retrieved and analyzed 120 to identify one or more potential sales territories for coverage 130. The sales territories may be ranked 140 based on one or more conditions including potential for sales growth and greatest possible return on investment. One or more capital contribution levels may be established 150. These capital contribution levels may be directly associated with the sales territory rankings 140. Each capital contribution level 150 is configured for receipt of a corresponding pre-determined amount from one or more contributors. The pre-determined amounts may be directed toward financing one or more sales representatives in the territory 160.

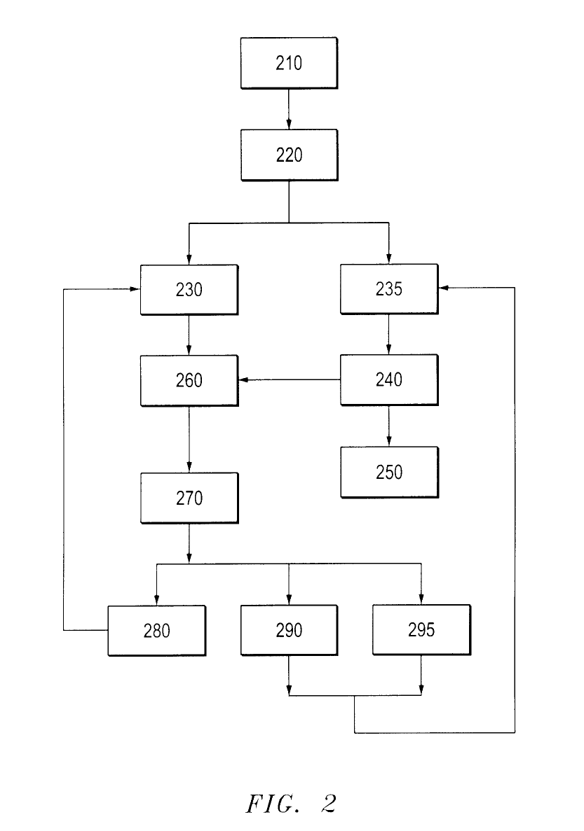

Referring now to FIG. 2, a company 210 seeking to obtain funding for the expansion of its outside sales force or expand sales coverage may set up a new business entity. The company 210 may itself assume the role of a general partner 230 having responsibility for the management and operation of the business entity. The business entity may be a limited partnership, limited liability partnership, a limited liability company or S-corporation. In one exemplary embodiment, the business entity may be a limited partnership 220.

The limited partnership or partnership 220 may vest powers in the general partner 230 to select, hire, train and employ individuals to serve as sales representatives 260 for the company's products or services in various sales territories across the country. In another embodiment, the general partner 230 may select, hire, train and employ individual to serve as sales representatives 260 for the company's and/or one or more other companies' products or services in various sales territories. The partnership 220 may compensate the sales representatives and reimburse their respective field expenses.

One or more existing shareholders of the company may be invited to become limited partners 235 in the partnership 220. The invitation may be extended based on a variety of factors, comprising solvency, pre-existing relationships, and capital contribution desired. In another embodiment, limited partnership may be offered to non-shareholders of the companies. A limited partner 235 may be an individual, a plurality of individuals, a business or company or a plurality of businesses or companies. The individuals and companies may or may not be directly affiliated to the company seeking to expand its sales coverage. The general partner 230 may also be a limited partner. The general partner 230 may then enjoy all the rights and be subject to all the obligations and duties of a limited partner 235. The roles and responsibilities and compensation of the general partner 230 and the one or more limited partners 235 may be contractually specified. The contractual agreement may further specify terms for transfer of partnership interests, including for instance, restriction on transfers by limited partners 235 without prior, written, consent of the general partner 230, and dissolution terms for the partnership 220.

The limited partner(s) 235 may finance the commercial activities of one or more sales representatives in one or more sales territories 240 by contributing capital associated with a capital contribution level. Capital may be contributed by the limited partners 235 on a continual or previously agreed upon basis and for a pre-determined period. The capital contributions may be made in cash or by the transfer of property. Each limited partner 235 may receive a percentage ownership stake or interest 250 in the limited partnership 220. The limited partners 235 may receive their respective limited partnership interests 250 in the partnership in amounts commensurate with their respective contributions to the partnership and with an expectation of a pre-determined annual return or accrued interest on such capital contributions.

The contributed capital may finance a full-time or a part-time sales representative in the sales territory for a pre-determined duration or period. In one embodiment, the pre-determined period may be between twelve to thirty six months. In another embodiment, the capital contribution may be continued until all sales objectives are satisfied or met in the sales territory.

The sales representatives may be hired and placed in sales territories where the general partner 230, in consultation with the limited partners 235, determines that market conditions warrant such placement. The partnership 220 may opt to restrict the establishment of sales representatives in each new territory for a fixed period. Territories with the greatest potential return on investment may be assigned a higher priority for sales representative placement. Higher priority territories are associated with a correspondingly higher ranking. A capital contribution level is associated with each sales territory ranking. Higher ranked territories have a correspondingly higher capital contribution level.

Each capital contribution level may be associated with a pre-determined capital contribution. This capital contribution may be directly related to the costs involved in selecting, training, and placing a sales representative in the territory and thereinafter financing the commercial activities of the sales representative in the territory. As described earlier, each capital contribution level may be directly related to a percentage ownership interest 250 in the limited partnership 220. In one embodiment, the general partner 230 may contribute a startup amount for the limited partnership 220. Thereafter, the general partner 230 may contribute time and management expertise as may be necessary for the selection, hiring, training and managing of sales representatives in various locations or territories across the country 260.

Separate capital accounts may be established and maintained for each limited partner 235 and general partner 230 in accordance with applicable Treasury Regulations, as amended from time to time. All capital contributions of the limited partners 235, its allocable share of partnership income and loss, and cash or property distributions made to each limited partner(s) 235 shall be credited or charged to the limited partner's individual capital contribution account. It may be pre-determined and contractually specified that each capital contribution account may accrue interest.

The general partner 230 may have full, exclusive, and complete discretion in the management and control of the partnership 220. The general partner 230 may also be responsible for any and all acts necessary appropriate the acquisition and management of the partnership and interests in the partnership. The limited partners 235 may not take part in the management of the partnership or transact any business for or on behalf of the partnership.

A percentage interest of a partner may be defined as that particular partner's interest in the capital, net income, net loss, and distributions of the partnership 220. The percentage interest of each partner may be determined by dividing the number of partnership interests which it holds by the total number of partnership interests outstanding at any given time.

Each limited partner 235 may be issued a partnership interest for every dollar contributed to the partnership 220. In an exemplary embodiment, the general partner 230 may be issued one thousand partnership interests in consideration a one thousand dollar contribution. A limited partner 235 contributing five thousand dollars may be issued five thousand partnership interests and so on. The percentage interest of each partner may be adjusted from time to time to account for the total amount contributed. Interest may be deemed to be accruing and recorded on contributions made by each partner at a pre-determined interest rate per annum.

The partnership 220 may continue to issue additional percentage ownership interests or limited partnership interests, at the discretion of the general partner 230, in connection with the engagement and support of sales representatives in other territories as may be determined by the general partner 230 at contribution rates to be further established.

When the sales objectives in a particular territory are met, the limited partner 235 responsible for financing the commercial activities of a sales representative in that territory 240 will be timely informed and the capital contributions by that limited partner 235 will be reduced accordingly so that no surplus builds up in its capital contribution account.

After contributions are no longer required to support sales activities in the relevant territory, the partnership 220 may receive a previously agreed upon amount as its commission for the sales in the sales territory 270. In one embodiment, the partnership may receive a percentage of net profits from the sales in the territory. The partnership 220 may initially reimburse the general partner 230 for expenses associated with recruiting, managing and supporting the sales representatives in the relevant sales territory 280. Excess revenues may be used, first, to pay the limited partners, pro rata in accordance with their respective percentage interests 290, the pre-determined return or interest on their capital contributions and, second, to repay their capital contributions 295 until all capital contributions have been fully repaid. The allocation and distribution of partnership revenues is applied in a manner consistent with applicable IRS Codes and promulgated treasury regulations.

As the capital contributions are repaid, the percentage interests evidencing the contributions may also be retired. This process may continue until all accrued interest has been paid and all contributions have been repaid for all percentage ownership interests and the ownership interests have been retired.

Pursuant to a written agreement approved by the general partner 230 or a majority of partnership interests, the general partner 230 or limited partners 235 may lend funds to the partnership 220 for partnership business. The amount of any loan or advance by a general partner 230 or limited partners 235 may bear interest according to pre-determined terms. Such loans may be deemed an obligation of indebtedness from the partnership to the general partner 230 or limited partners 235, and may be payable prior to any distributions to the partners.

If a limited partner 235 fails to keep up the monthly contributions for its percentage ownership interests, it may forfeit both accrual of interest and any right to partnership repurchase of its limited partnership interests.

The one or more embodiments of the invention may be implemented as a method, a computer-implemented method and a computer-implemented system. While the invention has been particularly shown, described and illustrated in detail with reference to one or more embodiments and modifications thereof, it should be understood by those skilled in the art that equivalent changes in form and detail may be made therein without departing from the true spirit and scope of the invention as claimed. To the extent such modifications fall within the scope of the appended claims and their equivalents, they are intended to be covered by this patent.

1. A computer-implemented method for funding an expanded market coverage, the method comprising:
identifying one or more sales territories for coverage;
assigning a pre-defined ranking to each of the sales territories;
establishing a capital contribution level for receipt of a corresponding pre-determined capital contribution, the capital contribution level associated with the sales territory ranking; and
directing the capital contribution toward financing one or more sales representatives placed in the sales territories.

2. The method of claim 1, further comprising receiving the capital contribution from one or more contributors.

3. The method of claim 1, wherein the sales representatives are financed continually until one or more pre-determined sales objectives are achieved in the sales territories.

4. The method of claim 1, wherein the identification of the sales territories further comprises:
determining one or more preliminary factors for the identification of the sales territories; and
retrieving and analyzing data satisfying the sales-territory identification factors.

5. The method of claim 4, wherein the preliminary factors comprise one or more geographic locations, demographic indicators, quantitative values or qualitative values.

6. The method of claim 5, wherein the data satisfying the sales-territory identification factors comprises information on current and/or historic sales of one or more products and/or services.

7. The method of claim 6, wherein the products are selected from the group consisting of prescription and over the counter pharmaceutical products and medical devices.

8. The method of claim 4, wherein the data satisfying the sales-territory identification factors comprises information on prescriptions written in the sales territory.

9. The method of claim 2, comprising disbursing a fixed percentage of net profits generated from sales in the sales territory to the one or more contributors.

10. The method of claim 9, wherein the disbursement comprises a pre-determined interest accrued on the capital contributions.

11. The method of claim 10, wherein the interest is disbursed pro-rata in accordance with the capital contribution level.

12. The method of claim 11, further comprising distributing surplus revenues, after payment of the interest, to the one or contributors until the capital contributions are completely repaid.

13. A method for funding an expanded market coverage, the method comprising:
setting up a new business entity, the business entity comprising a designated general partner and one or more limited partners;
determining one or more preliminary factors for the identification of one or more sales territories;
retrieving and analyzing data satisfying the sales-territory identification factors;
identifying the one or more sales territories for sales expansion;
assigning a pre-defined ranking to each of the identified sales territories;
establishing a capital contribution level for receipt of a corresponding pre-determined capital contribution from the one or more limited partners, the capital contribution level associated with the sales territory ranking; and
directing the capital contributions received toward financing one or more sales representatives placed in the sales territories.

14. The method of claim 13, wherein the sales territory ranking is based on future sales potential.

15. The method of claim 13, wherein each of the limited partners continually contributes their capital, for a pre-determined duration, to finance commercial activities of the one or more sales representatives placed in each of the sales territories.

16. The method of claim 13, wherein the business entity comprises a limited partnership, the limited partnership further comprising a general partner responsible for recruiting and managing the sales representatives.

17. The method of claim 15, wherein each of the limited partners acquires a percentage interest in the limited partnership commensurate to its capital contribution.

18. The method of claim 16, further comprising paying the limited partnership a fixed commission for sales in the sales territory.

19. The method of claim 18, further comprising paying, from the commission, each of the limited partners a pre-determined amount as interest accrued on their capital contribution, the amount corresponding to the capital contribution level.

20. The method of claim 19, further comprising paying off the capital contributions of each of the one or more limited partners from surplus revenues after payment of the accrued interest.

21. The method of claim 20, further comprising retiring each of the percentage interests in the limited partnership.

22. A computer-implemented system for funding an expanded market coverage, the system comprising:
a processor; and
a computer memory operatively coupled to the processor,
wherein the computer memory has disposed within it computer program instructions for:
identifying one or more sales territories for coverage;
assigning a pre-defined ranking to each of the sales territories;
establishing a capital contribution level for receipt of a corresponding pre-determined capital contribution, the capital contribution level associated with the sales territory ranking; and
directing the capital contribution toward financing one or more sales representatives placed in the sales territories.

23. The computer-implemented system of claim 22, further comprising computer program instructions for:
determining one or more preliminary factors for the identification of the sales territories; and
retrieving and analyzing data satisfying the sales-territory identification factors.

24. The computer-implemented system of claim 23, wherein the data satisfying the sales-territory identification factors comprises information on current and/or historic sales of one or more products and/or services.

25. The computer-implemented system of claim 24, wherein the products are selected from the group consisting of prescription and over the counter pharmaceutical products and medical devices.
